(19) United States
(12) Patent Application Publication
(10) Pub. No.: US 2010/0142650 A1
(43) Pub. Date: Jun. 10, 2010

(54) Apparatus and Method for Adaptive Rotation Angle Control, Wireless Apparatus, and Computer Program

(75) Inventors: Toshihiko Komine, Fujimino-shi (JP); Noriaki Miyazaki, Fujimino-shi (JP)

Correspondence Address: MORGAN LEWIS & BOCKIUS LLP, 1111 PENNSYLVANIA AVENUE NW, WASHINGTON, DC, 20004, US

(73) Assignee: KDDI Corporation, Tokyo (JP)

(21) Appl. No.: 12/516,644

(22) PCT Filed: Nov. 28, 2007
(86) PCT No.: PCT/JP2007/072917

§ 371 Date: Jan. 28, 2010

(30) Foreign Application Priority Data
Nov. 29, 2006 (JP) 2006-321558

(51) Int. Cl. H04L 27/00

(52) U.S. Cl. 375/324

(57) ABSTRACT

An adaptive rotation angle control apparatus of this invention includes a communication quality approximating equation storage portion which stores a communication quality approximating equation including as variables reception quality information, amplitude fluctuation information, and a rotation angle; a computation portion which substitutes into the communication quality approximating equation the reception quality information and amplitude fluctuation information of the input information, and a rotation angle, and calculates the value of the communication quality approximating equation; and an adaptive control portion which provides a rotation angle to the computation portion, receives from the computation portion communication quality information, which is the value of the communication quality approximating equation calculated using the rotation angle provided, and determines the optimum rotation angle based on the received communication quality information.

### TECHNICAL FIELD

The present invention relates to an apparatus and method for an adaptive rotation angle control, wireless apparatus, and computer program.

Priority is claimed on Japanese Patent Application No. 2006-321558, filed Nov. 29, 2006, the content of which is incorporated herein by reference.

### BACKGROUND ART

In recent years, multicarrier transmission methods have attracted attention as communication methods used in the new generation of mobile communication systems. Representative examples of multicarrier transmission methods include OFDM (orthogonal frequency division multiplexing) and MC-CDM (multi-carrier-code division multiplexing). In Non-patent Document 1, a rotation orthogonal code is proposed as an MC-CDM spreading code. The rotation orthogonal code Rn when the spreading factor is n is expressed by equation (1). The output signal vector s′ resulting when an input signal vector s is encoded by the rotation orthogonal code Rn is expressed by equation (2).

$$\begin{matrix}{R}_{2} = ( \begin{matrix}cos {θ}_{1} & sin {θ}_{1} \\ - sin {θ}_{1} & cos {θ}_{1}\end{matrix} ) \\ {R}_{n} = ( \begin{matrix}{R}_{n / 2} cos {θ}_{m} & {R}_{n / 2} sin {θ}_{m} \\ - {R}_{n / 2} sin {θ}_{m} & {R}_{n / 2} cos {θ}_{m}\end{matrix} ) , n = {2}^{m} , m = 2 , 3 , … , M & ( 1 ) \\ ( \begin{matrix}{s}_{1}^{′} \\ {s}_{2}^{′} \\ ⋮ \\ {s}_{n}^{′}\end{matrix} ) = {R}_{n} ( \begin{matrix}{s}_{1} \\ {s}_{2} \\ ⋮ \\ {s}_{n}\end{matrix} ) & ( 2 )\end{matrix}$$

Here, M is an integer greater than or equal to 2, and θ is a rotation angle (in radians). If the rotation angle θ is 0, then signal spreading is not performed, and the output signal is an OFDM signal. On the other hand, if the rotation angle θ is π/4, signals are spread uniformly, and the output signal is an MC-CDM signal employing a Walsh code. By assigning the rotation angle θ a value from 0 to π/4, the spreading factor of the signal spreading can be varied, the frequency diversity effect can be controlled, and the features of both OFDM and MC-CDM using a Walsh code can be obtained. In Non-patent Documents 2 through 4, it is reported that the rotation angle θ is affected by the spreading factor, the multiplexing order, the transmission path, the MCS (modulation and coding scheme), and other factors, and that the optimum rotation angle θ to minimize the error rate differs according to these parameters. Also, the use of a fixed rotation angle when applying a rotation orthogonal code to mobile communication systems is studied in Non-patent Document 4.

Non-patent Document 1: 3GPP TSG RAN WG1#42bis, R1-051261, “Enhancement of Distributed Mode for Maximizing Frequency Diversity,” October 2005.

Non-patent Document 2: 3GPP TSG RAN WG1#46, R1-062170, “Phase Adjustment Methods of Rotational CDM,” September 2006.

Non-patent Document 3: 3GPP TSG RAN WG1#46bis, R1-062804, “Phase Adjustment Methods of Rotational CDM for L1/L2 Control Channel,” October 2006.

Non-patent Document 4: 3GPP TSG-C WG3, C30-20060911-042, “The optimum rotational angle for R-OFDM,” September 2006.

### DISCLOSURE OF INVENTION

### Problem to be Solved by the Invention

However, the optimum rotation angle to minimize the error rate fluctuates due to momentary or long-term fluctuations in transmission path characteristics. For this reason, it is desirable that the optimum rotation angle be modified to improve communication quality according to changes in the transmission path characteristics.

The present invention was devised in light of these circumstances and has an object to provide an adaptive rotation angle control apparatus and method, as well as a wireless apparatus capable of optimally controlling the rotation angle applied to rotation orthogonal codes according to changes in transmission path characteristics in a mobile communication system which employs rotation orthogonal codes.

Another object of the present invention is to provide a computer program and storage media thereof, to realize an adaptive rotation angle control apparatus of the present invention through the use of a computer.

### Means for Solving the Problem

In order to resolve the above problems, an adaptive rotation angle control apparatus of the present invention receives reception quality information and amplitude fluctuation information as input information to control a rotation angle used in a rotation orthogonal code, and includes: a communication quality approximating equation storage portion which stores a communication quality approximating equation including variables representing reception quality information, amplitude fluctuation information, and a rotation angle; a computation portion which substitutes into the communication quality approximating equation the reception quality information and the amplitude fluctuation information received as the input information, and a rotation angle; and an adaptive control portion which supplies a rotation angle to the computation portion, receives from the computation portion communication quality information which is a value obtained from the communication quality approximating equation calculated using the rotation angle supplied from the adaptive control portion, and decides an optimum rotation angle based on the received communication quality information.

A wireless apparatus of the present invention in a mobile communication system which employs a rotation orthogonal code, includes the adaptive rotation angle control apparatus described above, and employs the rotation angle controlled by the adaptive rotation angle control apparatus in the rotation orthogonal code.

An adaptive rotation angle control method of the present invention in which reception quality information and amplitude fluctuation information are provided as input information to control a rotation angle used in a rotation orthogonal code, includes the steps of: calculating a value of a communication quality approximating equation including variables representing reception quality information, amplitude fluctuation information, and a rotation angle by substituting a rotation angle, and the reception quality information and the amplitude fluctuation information provided as the input information, into the communication quality approximating equation; modifying the rotation angle provided in the calculating step; and determining an optimum rotation angle based on a communication quality information which is the value of the communication quality approximating equation calculated in the calculating step.

A computer program or a storage medium storing the computer program of the present invention performs processing to control a rotation angle used in a rotation orthogonal code utilizing reception quality information and amplitude fluctuation information provided as input information, and causes a computer to execute the steps of: calculating a value of a communication quality approximating equation including variables representing reception quality information, amplitude fluctuation information, and a rotation angle by substituting a rotation angle, and the reception quality information and the amplitude fluctuation information provided as the input information, into the communication quality approximating equation; modifying the rotation angle provided in the calculating step; and determining an optimum rotation angle based on a communication quality information which is the value of the communication quality approximating equation calculated in the calculating step.

By this means, the above-described adaptive rotation angle control apparatus can be realized through the use of a computer.

### EFFECT OF THE INVENTION

By means of this invention, in a mobile communication system employing a rotation orthogonal code, the rotation angle used in the rotation orthogonal code can be optimally controlled according to changes in the transmission path characteristics.

### BRIEF DESCRIPTION OF THE DRAWINGS

FIG. 1 is a block diagram showing a mobile communication system according to an embodiment of the invention;

FIG. 2 is a block diagram showing an adaptive rotation angle control portion shown in FIG. 1;

FIG. 3 is a flowchart showing a method for generating a communication quality approximating equation in the embodiment of the invention; and,

FIG. 4 is a block diagram showing a device for generating a communication quality approximating equation in the embodiment of the invention.

### REFERENCE SYMBOLS

1 Wireless transmitter

2 Wireless receiver

11 Modulator

12 Rotation orthogonal encoder

13 Multiplexer

21 Demultiplexer

22 Multidimensional demodulator

23 Transmission path information calculation portion

24 Adaptive rotation angle control portion

41 Communication quality approximating equation storage portion

42 Computation portion

43 Adaptive control portion

50 Communication quality approximating equation generation device

51 Rotation orthogonal code generation portion

52 Rotation orthogonal code information storage portion

53 Encoding calculation equation generation portion

54 Fading addition calculation equation generation portion

55 Euclidean distance calculation equation generation portion

56 Conditional probability calculation equation generation portion

57 Communication quality approximating equation generation portion

### BEST MODE FOR CARRYING OUT THE INVENTION

Below, an aspect of the present invention is explained with reference to the drawings.

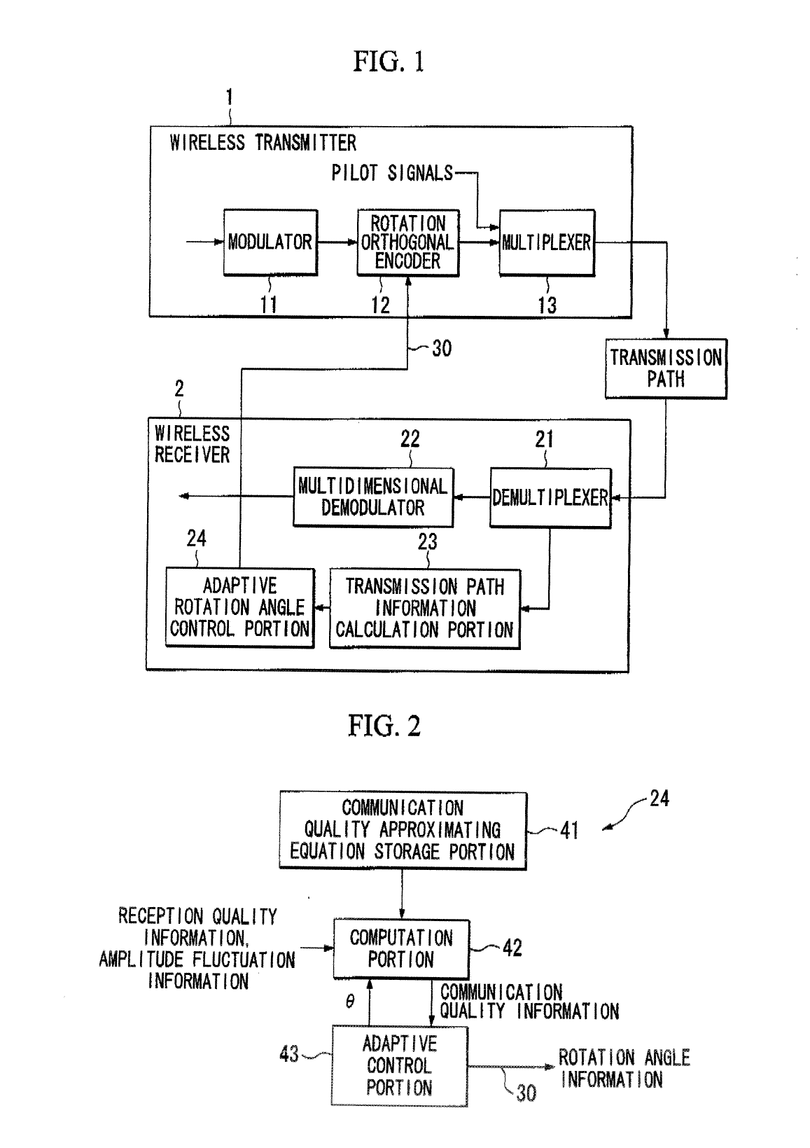

FIG. 1 is a block diagram showing a mobile communication system according to an embodiment of the invention.

This mobile communication system adopts a multicarrier transmission method which performs signal spreading using a rotation orthogonal code. In FIG. 1, the wireless transmitter 1 has a modulator 11, a rotation orthogonal encoder 12, and a multiplexer 13. The wireless receiver 2 has a demultiplexer 21, a multidimensional demodulator 22, a transmission path information calculation portion 23, and an adaptive rotation angle control portion 24. In FIG. 1, constituent portions relating to the present invention are shown, and other portions are omitted.

In the wireless transmitter 1, the modulator 11 modulates the transmission data. This modulated signal is series/parallel converted and is then input to the rotation orthogonal encoder 12. The rotation orthogonal encoder 12 uses a rotation orthogonal code to perform spreading of the modulated signal over the frequency domain or over the me domain. This spread signal is input to the multiplexer 13. The multiplexer 13 performs multiplexing of the spread signal with a pilot signal in the frequency domain or the time domain. Guard interval signals are inserted into this multiplexed signal, which is wirelessly transmitted. The wireless signal propagates passes over the transmission path and is received by the wireless receiver 2.

In the wireless receiver 2, wirelessly received reception signals are input to the demultiplexer 21 after removal of guard interval signals. The demultiplexer 21 demultiplexes signals by performing processing opposite to that of the multiplexer 13. The signals other than pilot signals which have been demultiplexed by the demultiplexer 21 are input to the multidimensional demodulator 22. The multidimensional demodulator 22 performs multidimensional demodulation of the input signals, which demodulates the reception signals. In this multidimensional demodulation processing, signal determination is performed by comparing the distances between reception signals and reference signals on the frequency axis (or on the time axis) without performing despreading.

The pilot signals demultiplexed by the demultiplexer 21 are input to the transmission path information calculation portion 23. The pilot signals are known signals. The transmission path information calculation portion 23 calculates reception quality information and amplitude fluctuation information based on the received pilot signals. The reception quality information and amplitude fluctuation information are input to the adaptive rotation angle control portion 24.

Based on the reception quality information and amplitude fluctuation information, the adaptive rotation angle control portion 24 calculates the optimum rotation angle.

Rotation angle information 30 which indicates this calculated rotation angle is sent to the wireless transmitter 1.

The wireless transmitter 1 generates the rotation orthogonal code used by the rotation orthogonal encoder 12 based on the rotation angle information 30 sent from the wireless receiver 2. This rotation orthogonal code is generated using equation (1), employing the rotation angle indicated by the rotation angle information 30. The spreading factor is set in advance.

FIG. 2 is a block diagram showing the configuration of the adaptive rotation angle control portion 24 shown in FIG. 1. In FIG. 2, the adaptive rotation angle control portion 24 has a communication quality approximating equation storage portion 41, a computation portion 42, and an adaptive control portion 43.

The communication quality approximating equation storage portion 41 stores in advance a communication quality approximating equation. The communication quality approximating equation has as variables reception quality information, amplitude fluctuation information, and a rotation angle. The reception quality information, amplitude fluctuation information, and communication quality approximating equation are described later.

The computation portion 42 reads the communication quality approximating equation from the communication quality approximating equation storage portion 41, and calculates the communication quality approximating equation. The computation portion 42 substitutes into the communication quality approximating equation the reception quality information, amplitude fluctuation information input from the transmission path information calculation portion 23, and the rotation angle θ input from the adaptive control portion 43, and calculates the value of the communication quality approximating equation. This calculated value is the communication quality information. The computation portion 42 outputs the communication quality information to the adaptive control portion 43.

The adaptive control portion 43 provides a rotation angle θ to the computation portion 42, and receives the communication quality information calculated using this rotation angle θ from the computation portion 42. Upon input from the transmission path information calculation portion 23 of reception quality information and amplitude fluctuation information, the adaptive control portion 43 causes the computation portion 42 to calculate communication quality information sequentially while changing the value of the rotation angle θ, in order to determine the optimum rotation angle. Next, the adaptive control portion 43 determines the best communication quality information from among the communication quality information received from the computation portion 42, and decodes the rotation angle θ as the optimum rotation angle used in calculating the best communication quality information. The adaptive control portion 43 outputs rotation angle information 30 indicating this optimum rotation angle.

According to this embodiment, the optimum rotation angle which minimizes the error rate can be determined based on reception quality information and amplitude modulation information. By this means, in a mobile communication system which employs a rotation orthogonal code, the rotation angle used in the rotation orthogonal code can be optimally controlled according to changes in the transmission path characteristics.

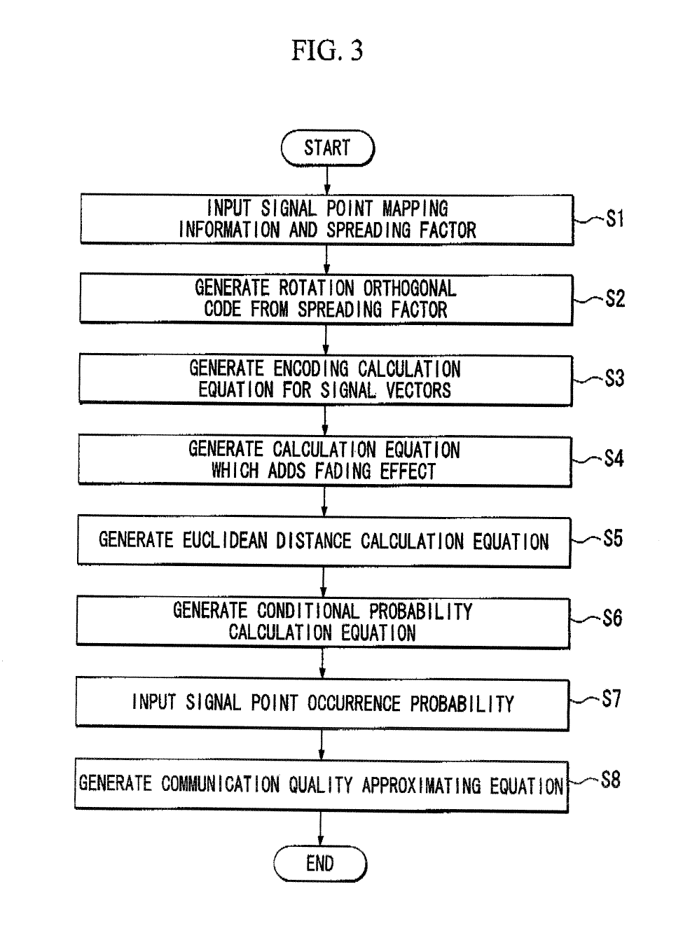

Next, a method of generating the communication quality approximating equation of this embodiment is explained. FIG. 3 is a flowchart showing the procedure of a method for generating the communication quality approximating equation. This communication quality approximating equation generation method can be used in a method of computer control when generating a communication quality approximating equation on a computer.

In FIG. 3, signal point mapping information and the spreading factor are input in step S1. Here, as the signal point mapping information, signal vectors sᵢ(sᵢ₁, sᵢ₂, . . . , sᵢₙ)^{T} which are mapping information for signal points i in an n-dimensional space in the frequency domain or in the time domain, are used. Here, ^{T}denotes the transpose matrix. Also, the spreading factor at this time is n.

In step S2, a rotation orthogonal code Rn is generated from the spreading factor n. The rotation orthogonal code Rn can be generated using the same equation (3) as equation (1) above. Here, M is an integer greater than or equal to 2, and θ is a variable representing the rotation angle.

$${R}_{2} = ( \begin{matrix}cos {θ}_{1} & sin {θ}_{1} \\ - sin {θ}_{1} & cos {θ}_{1}\end{matrix} ) \\ {R}_{n} = ( \begin{matrix}{R}_{n / 2} cos {θ}_{m} & {R}_{n / 2} sin {θ}_{m} \\ - {R}_{n / 2} sin {θ}_{m} & {R}_{n / 2} cos {θ}_{m}\end{matrix} ) , n = {2}^{m} , m = 2 , 3 , … , M \qquad ( 3 )$$

In step S3, an encoding calculation equation to encode the signal vectors sᵢ using the rotation orthogonal code Rn is generated. The encoding calculation equation for the signal vectors sᵢ can be generated using equation (4). Here s′ᵢ(s′ᵢ₁, s′ᵢ₂, . . . , s′ᵢₙ)^{T} are the signal vectors after encoding of the signal vectors sᵢ.

$$( \begin{matrix}{s}_{i 1}^{′} \\ {s}_{i 2}^{′} \\ ⋮ \\ {s}_{i n}^{′}\end{matrix} ) = {R}_{n} ( \begin{matrix}{s}_{i 1} \\ {s}_{i 2} \\ ⋮ \\ {s}_{i n}\end{matrix} ) \qquad ( 4 )$$

In step S4, a calculation equation with fading effects added is generated for the signal vectors s′ᵢ. This calculation equation can be generated using equation (5). Here, rᵢ(rᵢ₁, rᵢ₂, rᵢₙ)^{T} are the signal vectors after fading effects have been added to the signal vectors s′ᵢ. Also, f(f₁, f₂, . . . , fₙ) is a vector representing amplitude fluctuations due to the transmission path. This amplitude fluctuation vector represents amplitude fluctuations applied by the transmission path to each signal point spread in n-dimensional space with the spreading factor n. The elements f₁, f₂, . . . , fₙ of the amplitude fluctuation vector are given as variables. The elements f₁, f₂, . . . , fₙ of the amplitude fluctuation vector correspond to amplitude fluctuation information.

$$( \begin{matrix}{r}_{i 1} \\ {r}_{i 2} \\ ⋮ \\ {r}_{i n}\end{matrix} ) = ( \begin{matrix}{s}_{i 1}^{′} \\ {s}_{i 2}^{′} \\ ⋮ \\ {s}_{i n}^{′}\end{matrix} ) ( {f}_{1} {f}_{2} … {f}_{n} ) \qquad ( 5 )$$

In this embodiment, a wireless communication system which can compensate for phase rotation due to the transmission path is assumed. For example, it is assumed that the phase of reception signals is corrected by a receiver using known pilot signals comprised by the transmission signals of the transmitter. For this reason, only amplitude fluctuation is handled as a fading effect.

In step S5, a calculation equation for the Euclidean distances of signal vectors rᵢ is generated. This calculation equation can be generated using equation (6). Here dᵢⱼ is the Euclidean distance between signal point i and signal point j in n-dimensional space.

dᵢⱼ=\sqrt{(rᵢ₁−rⱼ₁)²+(rᵢ₂−rⱼ₂)²+ . . . +(rᵢₙ−jn)²} (6)

In step S6, a conditional probability calculation equation is generated. This conditional probability is the probability of an error such that the reception signal vector r at the receiver is a different signal point j due to amplitude fluctuation over the transmission path and the effect of AWGN, when the signal vector s′ᵢ after encoding of the signal vector sᵢ is transmitted from the transmitter. This calculation equation can be generated using equations (7) and (8).

$$\begin{matrix}{P}_{s} ( {r}_{j} \vert {s}_{i}^{′} ) = Q ( \frac{{d}_{ij}}{2 σ} ) = Q ( \sqrt{\frac{2 {E}_{b}}{{N}_{0}}} \frac{{d}_{ij}^{′}}{2} ) & ( 7 ) \\ Q ( x ) = {\int }_{x}^{∞} \frac{1}{\sqrt{2 π}} exp ( - \frac{{u}^{2}}{2} ) d u & ( 8 )\end{matrix}$$

Here, Pₛ(rⱼ|s′ᵢ) is the probability of an error such that the reception signal vector r is a different signal point j due to amplitude fluctuation over the transmission path and the effect of AWGN, when the signal vector s′ᵢ is transmitted. Also, Q(x) is an error interpolation function, and dᵢⱼ is the Euclidean distance in n-dimensional space between the transmission signal vector rᵢ and the reception signal vector rⱼ. Further, σ is the noise power, E_{b} is the signal power density per bit, and N₀ is the noise power spectrum density. d′ᵢⱼ is defined by the following relation.

dᵢⱼ=\sqrt{Eb}×d′ᵢⱼ

In equation (7), E_{b}/N₀ is given as a variable. E_{b}/N₀ corresponds to the reception quality information.

In step S7, the signal point occurrence probability is input. The probability of occurrence of a signal vector s′ᵢ is P(s′ᵢ).

In step S8, a communication quality approximating equation to obtain an approximating equation for communication quality information is generated. Here, an explanation is given which uses the average symbol error rate and average bit error rate as examples of communication quality information.

Because equation (9) below obtains, a communication quality approximating equation in order to obtain an approximate value of the average symbol error rate can be generated from equation (10), using a calculation equation for the probability of occurrence P(s′ᵢ) of the signal vector s′ᵢ and for the conditional probability Pₛ(rⱼ|s′ᵢ). Equation (9) expresses the conditional probability, which is the symbol error rate when the signal vector s′ᵢ is transmitted. Here Pₛ is an approximate value of the average symbol error rate when the signal vector s′ᵢ is transmitted with the probability of occurrence P(s′ᵢ).

$$\begin{matrix}{P}_{s} ( r \vert {s}_{i}^{′} ) \leq {\sum }_{j = 1 , j \neq i} {P}_{s} ( {r}_{j} \vert {s}_{i}^{′} ) & ( 9 ) \\ {P}_{s} = {\sum }_{i = 1} P ( {s}_{i}^{′} ) \cdot {P}_{s} ( r \vert {s}_{i}^{′} ) & ( 10 )\end{matrix}$$

Because the following equation (11) obtains, a communication quality approximating equation in order to obtain an approximate value for the average bit error rate can be generated from equation (12) using a calculation equation for the probability of occurrence P(s′ᵢ) of the signal vector s′ᵢ and for the conditional probability Pₛ(rⱼ|s′ᵢ). Equation (11) expresses the conditional probability, which is the bit error rate when the signal vector s′ᵢ is transmitted.

$$\begin{matrix}{P}_{b} ( r \vert {s}_{i}^{′} ) \leq {\sum }_{j = 1 , j \neq i} \frac{{H}_{ij}}{I} \cdot {P}_{s} ( {r}_{j} \vert {s}_{i}^{′} ) & ( 11 ) \\ {P}_{b} = {\sum }_{i = 1} P ( {s}_{i}^{′} ) \cdot {P}_{b} ( r \vert {s}_{i}^{′} ) & ( 12 )\end{matrix}$$

Here Hᵢⱼ is the Hamming distance between the signal vector s′ᵢ and the signal vector s′ⱼ. Also, I is the number of information bits per symbol, and P_{b} is an approximate value of the average bit error rate when a signal vector s′ᵢ is transmitted with probability of occurrence P(s′ᵢ). The Hamming distance Hᵢⱼ and the number of information bits I are provided as input information. The number of information bits I and bit mapping information may be provided as input information, and the Hamming distance Hᵢⱼ may be calculated from the number of information bits I and the bit mapping information. The bit mapping information indicates the allocation of information bits to symbols.

The communication quality approximating equation obtained in this embodiment has as variables the reception quality information E_{b}/N₀, the amplitude fluctuation information f₁, f₂, . . . , fₙ, and the rotation angle θ. Hence by providing the reception quality information E_{b}/N₀, the amplitude fluctuation information f₁, f₂, . . . , fₙ and the rotation angle θ to the communication quality approximating equation, communication quality information can be calculated. For example, from equation (10), an approximate value for the average symbol error rate can be calculated. From equation (12), an approximate value for the average bit error rate can be calculated.

Further, the communication quality approximating equation of this embodiment corresponds to a multicarrier transmission method, and the effect of fading can be incorporated for each subcarrier. Hence, the precision of the communication quality information can be improved.

Next, a specific example is used to further explain the above-described communication quality approximating equation and the method of generating this equation. Here, as one example, the modulation method is QPSK (quadrature phase shift keying, quadri-phase shift keying), the spreading factor is 2 with spreading performed in the frequency domain, and an approximating equation for the average bit error rate is generated. A wireless communication system is assumed which can perform compensation for phase rotation due to the transmission path.

First, the signal vectors sᵢ(sᵢ₁, sᵢ₂)^{T} in a two-dimensional space in the frequency domain are mapped to QPSK symbols represented by equation (13), according to each signal point. Then, the information of equation (13) is input as signal point mapping information. Input is performed for a spreading factor n of 2.

sᵢ=(\sqrt{E_{b}}, \sqrt{E_{b}})^{T}

s₂=(−\sqrt{E_{b}}, \sqrt{E_{b}})^{T}

s₃=(\sqrt{E_{b}}, −\sqrt{E_{b}})^{T}

s₄=(−\sqrt{E_{b}}, −\sqrt{E_{b}})^{T} (13)

Next, the rotation orthogonal code R₂ when the spreading factor n is 2 is generated. The rotation orthogonal code R₂ is obtained using equation (3). Next, an encoding calculation equation which performs encoding of signal vectors sᵢ using the rotation orthogonal code R₂ is generated. The encoding calculation equation for signal vectors sᵢ is given by equation (14). Here θ₁ is the rotation angle.

$$( \begin{matrix}{s}_{i 1}^{′} \\ {s}_{i 2}^{′}\end{matrix} ) = ( \begin{matrix}cos {θ}_{1} & sin {θ}_{1} \\ - sin {θ}_{1} & cos {θ}_{1}\end{matrix} ) ( \begin{matrix}{s}_{i 1} \\ {s}_{i 2}\end{matrix} ) = ( \begin{matrix}{s}_{i 1} cos {θ}_{1} + {s}_{i 2} sin {θ}_{1} \\ - {s}_{i 1} sin {θ}_{1} + {s}_{i 2} cos {θ}_{1}\end{matrix} ) \qquad ( 14 )$$

Next, a calculation equation which adds the effect of fading to the signal vector s′ᵢ is generated. This calculation equation is equation (15). Here f(f₁, f₂) is the vector for amplitude fluctuation due to the transmission path.

$$\begin{matrix}( \begin{matrix}{r}_{i 1} \\ {r}_{i 2}\end{matrix} ) = ( \begin{matrix}{s}_{i 1}^{′} \\ {s}_{i 2}^{′}\end{matrix} ) ( {f}_{1} {f}_{2} ) \\ = ( \begin{matrix}{s}_{i 1} cos {θ}_{1} + {s}_{i 2} sin {θ}_{1} \\ - {s}_{i 1} sin {θ}_{1} + {s}_{i 2} cos {θ}_{1}\end{matrix} ) ( {f}_{1} {f}_{2} ) \\ = ( \begin{matrix}{f}_{1} ( {s}_{i 1} cos {θ}_{1} + {s}_{i 2} sin {θ}_{1} ) \\ {f}_{2} ( - {s}_{i 1} sin {θ}_{1} + {s}_{i 2} cos {θ}_{1} )\end{matrix} )\end{matrix} \qquad ( 15 )$$

Next, a calculation equation for the Euclidean distance between signal points of signal vectors rⁱ is generated. This calculation equation can be generated using equation (16). Here dᵢⱼ is the Euclidean distance between signal point i and signal point j in two-dimensional space.

dᵢⱼ=\sqrt{(rᵢ₁−rⱼ₁)²+(rᵢ₂−rⱼ₂)²} (16)

The Euclidean distances d₁₂, d₁₃, d₁₄, d₂₃ are given by equation (17).

d₁₂=\sqrt{E_{b}}·\sqrt{4f₁² sin² θ₁′4f₂² cos² θ₁}

d₁₃=\sqrt{E_{b}}·\sqrt{4f₁² cos² θ₁+4f₂² sin² θ₁}

d₁₄=\sqrt{E_{b}}·\sqrt{f₁²(2 cos θ₁+2 sin θ₁)²+f₂²(2 cos θ₁−2 sin θ₁)²}

d₂₃=\sqrt{E_{b}}·\sqrt{f₁²(2 cos θ₁−2 sin θₐ)²+f₂²(−2 cos θ₁−2 sin θ₁)²} (17)

From the QPSK mapping information of equation (13), as Euclidean distance elations, the following obtain:

d₁₂=d₂₁=d₃₄=d₄₃

d₁₃=d₃₁=d₂₄=d₄₂

d₁₄=d₄₁

d₂₃=d₃₂

Next, the bit error rate when signal vectors s′ᵢ are used as transmission signal vectors is expressed by equation (18) (and the cases for signal vectors s′₂, s′₃, s′₄ are similarly expressed), so that equation (19) is an approximating equation for the average bit error rate. Here the method of signal point arrangement is assumed to be Gray mapping; in this case, the Hamming distance Hᵢⱼ between a signal vector s′₁ and a signal vector s′ⱼ is

H₁₂=H₁₃=H₂₁=H₃₁=H₂₄=H₄₂=H₃₄=H₄₃=1

H₁₄=H₂₃=H₄₁=H₃₂=2

In the case of QPSK, the number of information bits per symbol is 2. Also, the transmission signal vectors s′₁, s′₂, s′₃, s′₄ are assumed to all occur with equal probability.

$$\begin{matrix}\begin{matrix}{P}_{b} ( r \vert {s}_{1}^{′} ) = \frac{{H}_{12}}{I} \cdot {P}_{s} ( {r}_{2} \vert {s}_{1}^{′} ) + \frac{{H}_{13}}{I} \cdot \\ {P}_{s} ( {r}_{3} \vert {s}_{1}^{′} ) + \frac{{H}_{14}}{I} \cdot {P}_{s} ( {r}_{4} \vert {s}_{1}^{′} ) \\ = \frac{1}{2} \cdot Q ( \sqrt{\frac{2 {E}_{b}}{{N}_{0}}} \sqrt{{f}_{1}^{2} {sin}^{2} {θ}_{1} + {f}_{2}^{2} {cos}^{2} {θ}_{1}} ) + \\ \frac{1}{2} \cdot Q ( \sqrt{\frac{2 {E}_{b}}{{N}_{0}}} \sqrt{{f}_{1}^{2} {cos}^{2} {θ}_{1} + {f}_{2}^{2} {sin}^{2} {θ}_{1}} ) + \\ \frac{2}{2} \cdot Q ( \sqrt{\frac{2 {E}_{b}}{{N}_{0}}} \frac{\sqrt{\begin{matrix}{{f}_{1}^{2} ( 2 cos {θ}_{1} + 2 sin {θ}_{1} )}^{2} + \\ {f}_{2}^{2} ( 2 cos {θ}_{1} - 2 sin {θ}_{1} )\end{matrix}}}{2} )\end{matrix} & ( 18 ) \\ \begin{matrix}{P}_{b} = {\sum }_{i = 1}^{4} P ( {s}_{i}^{′} ) \cdot {P}_{b} ( r \vert {s}_{i}^{′} ) \\ = \frac{1}{2} \cdot Q ( \sqrt{\frac{2 {E}_{b}}{{N}_{0}}} \sqrt{{f}_{1}^{2} {sin}^{2} {θ}_{1} + {f}_{2}^{2} {cos}^{2} {θ}_{1}} ) + \\ \frac{1}{2} \cdot Q ( \sqrt{\frac{2 {E}_{b}}{{N}_{0}}} \sqrt{{f}_{1}^{2} {cos}^{2} {θ}_{1} + {f}_{2}^{2} {sin}^{2} {θ}_{1}} ) + \\ \frac{1}{4} \cdot Q ( \sqrt{\frac{2 {E}_{b}}{{N}_{0}}} \sqrt{\frac{\begin{matrix}{{f}_{1}^{2} ( 2 cos {θ}_{1} + 2 sin {θ}_{1} )}^{2} + \\ {{f}_{2}^{2} ( 2 cos {θ}_{1} - 2 sin {θ}_{1} )}^{2}\end{matrix}}{2}} ) + \\ \frac{1}{4} \cdot Q ( \sqrt{\frac{2 {E}_{b}}{{N}_{0}}} \frac{\sqrt{\begin{matrix}{{f}_{1}^{2} ( 2 cos {θ}_{1} + 2 sin {θ}_{1} )}^{2} + \\ {{f}_{2}^{2} ( - 2 cos {θ}_{1} - 2 sin {θ}_{1} )}^{2}\end{matrix}}}{2} )\end{matrix} & ( 19 )\end{matrix}$$

In the above-described embodiment, equation (19) is obtained as an approximating equation for the average bit error rate. By providing the reception quality information E_{b}/N₀, amplitude fluctuation information f₁, f₂, and rotation angle θ₁ to equation (19), an approximate value for the average bit error rate can easily be calculated.

According to this embodiment, equation (19) is stored in advance in the communication quality approximating equation storage portion 41 of FIG. 2. Also, the transmission path information calculation portion 23 of FIG. 1 calculates the reception quality information E_{b}/N₀ and the amplitude fluctuation information f₁, f₂ based on received pilot signals. By this means, the computation portion 42 of FIG. 2 can then substitute the reception quality information E_{b}/N₀, the amplitude fluctuation information f₁, f₂, and a rotation angle θ into equation (19), to calculate an approximate value for the average bit error rate. As the reception quality information E_{b}/N₀, for example, the SNR (Signal to Noise Ratio) value can be used.

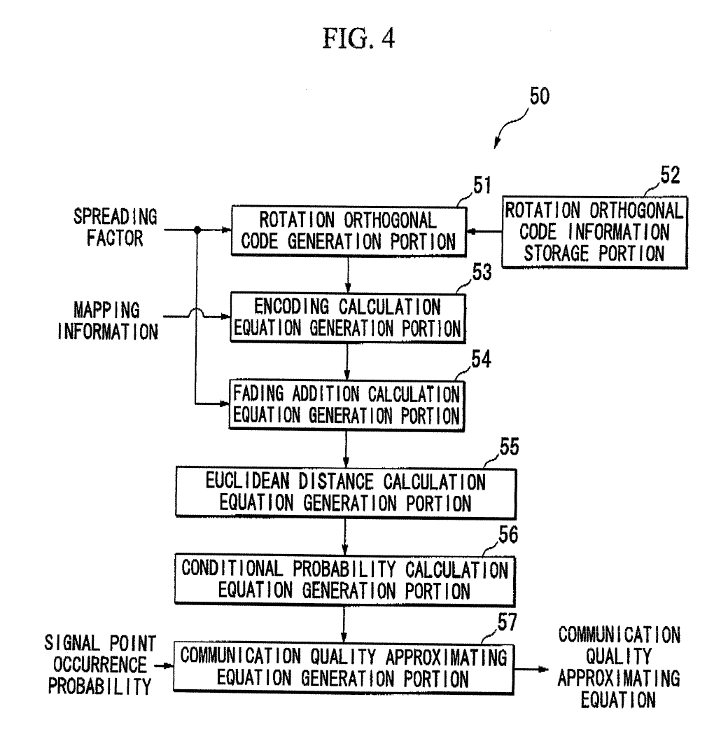

The communication quality approximating equation of this aspect may also be generated by a dedicated generation device. FIG. 4 is a block diagram showing the configuration of a communication quality approximating equation generation device 50. In FIG. 4, the spreading factor, mapping information, and signal point occurrence probabilities are provided as input information to the communication quality approximating equation generation device 50.

Based on the spreading factor of the input information, the rotation orthogonal code generation portion 51 generates a rotation orthogonal code having the rotation angle as a variable. At this time, the rotation orthogonal code generation portion 51 reads rotational orthogonal code information from the rotation orthogonal code information storage portion 52. The rotation orthogonal code information storage portion 52 stores rotation orthogonal code information in advance. The rotation orthogonal code information is information based on equation (3), and is information used to generate a rotation orthogonal code from a spreading factor. The rotation orthogonal code generation portion 51 outputs the generated rotation orthogonal code to the encoding calculation equation generation portion 53.

The encoding calculation equation generation portion 53 uses equation (4) to generate an encoding calculation equation, to perform encoding of signal vectors represented by mapping information in the input information, using a rotation orthogonal code. The encoding calculation equation generation portion 53 outputs the generated encoding calculation equation to the fading addition calculation equation generation portion 54.

The fading addition calculation equation generation portion 54 prepares a variable representing amplitude fluctuation information corresponding to the spreading factor of the input information. The fading addition calculation equation generation portion 54 uses the variable representing this amplitude fluctuation information to generate a fading addition calculation equation, with the effect of fading added to the encoding equation calculation, using equation (5). This fading addition calculation equation has as variables the rotation angle and the amplitude fluctuation information. The fading addition calculation equation generation portion 54 outputs the generated fading addition calculation equation to the Euclidean distance calculation equation generation portion 55.

The Euclidean distance calculation equation generation portion 55 generates a Euclidean distance calculation equation from equation (6), using the fading addition calculation equation. The Euclidean distance calculation equation generation portion 55 outputs the generated Euclidean distance calculation equation to the conditional probability calculation equation generation portion 56.

The conditional probability calculation equation generation portion 56 generates a conditional calculation equation using equations (7) and (8), including a variable representing reception quality information, from the Euclidean distance calculation equation. This conditional probability calculation equation has as variables the rotation angle, amplitude fluctuation information, and reception quality information. The conditional probability calculation equation generation portion 56 outputs the generated conditional probability calculation equation to the communication quality approximating equation generation portion 57.

The communication quality approximating equation generation portion 57 generates a communication quality approximating equation from the signal point occurrence probabilities of the input information and from the conditional probability calculation equation. An approximating equation for the average symbol error rate is generated using equation (10). An approximating equation for the average bit error rate is generated using equation (12). When generating an approximating equation for the average bit error rate, the Hamming distance and number of information bits are further provided as input information. Alternatively, the number of information bits and bit mapping information may be provided as input information, and the Hamming distance may be calculated from the number of information bits and the bit mapping information.

By this means, a communication quality approximating equation may for example be provided to the adaptive rotation angle control portion 24 shown in FIG. 1 by the communication quality approximating equation generation device 50, via communication circuits. By this means, the communication quality approximating equation can be updated as appropriate.

Further, the adaptive rotation angle control portion of this embodiment may be realized by dedicated hardware, or may be configured by means of memory and a DSP (digital signal processor) or other computation and processing device. On the other hand, the functions may be realized by execution of a program used to realize the functions of the adaptive rotation angle control portion 24 shown in FIG. 2.

Moreover, a program to realize the functions of the adaptive rotation angle control portion 24 shown in FIG. 2 may be recorded on computer-readable storage media, and the program recorded on this storage media may be read and executed by a computer system to perform adaptive rotation angle control processing. Here, a “computer system” may include an OS, peripheral equipment, or other hardware.

Further, the “computer system”, when utilizing the Internet, may also include a web page provision environment (or display environment).

Further, “computer-readable storage media” means a flexible disk, magneto-optical disc, ROM, flash memory or other writable nonvolatile memory, CD-ROM or other removable media, or a hard disk or other storage system incorporated within a computer system.

Further, “computer readable storage media” also includes members which hold the program for a fixed length of time, such as volatile memory (for example, DRAM (dynamic random access memory)) within a computer system serving as a server or client, when the program is transmitted via the Internet, other networks, telephone circuits, or other communication circuits.

Further, the program may be transmitted from a computer system which has stored the program in a storage device or a similar computer system, via transmission media, or by means of transmission waves in transmission media. Here, “transmission media” for transmission of the program is media having functions for transmitting information, such as the Internet, other networks (communication network), telephone circuits, or other communication circuits (communication lines).

Further, the program may be a program to realize a portion of the above-described functions.

Further, the above-described functions may be realized, in combination with programs recorded in advance in a computer system, by a so-called differential file (differential program).

As described above, an embodiment of the present invention has been explained in detail referring to the drawings; however, the specific configuration is not limited to this embodiment, and modifications of design and or the like which do not deviate from the gist of the invention are also included.

For example, in the above-described embodiment, the wireless receiver comprises an adaptive rotation angle control portion; however, the wireless transmitter may comprise an adaptive rotation angle control portion. When the wireless transmitter comprises an adaptive rotation angle control portion, reception quality information and amplitude fluctuation information are sent from the wireless receiver to the wireless transmitter.

The adaptive rotation angle control portion may be provided independently of the wireless transmitter and wireless receiver. In this case, reception quality information and amplitude fluctuation information are provided from the wireless receiver to the adaptive rotation angle control portion, and rotation angle information is sent from the adaptive rotation angle control portion to the wireless transmitter.

### INDUSTRIAL APPLICABILITY

This invention can be used in mobile communication systems which employ a rotation orthogonal code, and enable optimal control of the rotation angle used in the rotation orthogonal code according to changes in transmission path characteristics,

1. An adaptive rotation angle control apparatus which receives reception quality information and amplitude fluctuation information as input information to control a rotation angle used in a rotation orthogonal code, said adaptive rotation angle control apparatus comprising:
a communication quality approximating equation storage portion which stores a communication quality approximating equation including variables representing reception quality information, amplitude fluctuation information, and a rotation angle;
a computation portion which substitutes into said communication quality approximating equation said reception quality information and said amplitude fluctuation information received as said input information, and a rotation angle; and
an adaptive control portion which supplies a rotation angle to said computation portion, receives from said computation portion communication quality information which is a value obtained from said communication quality approximating equation calculated using said rotation angle supplied from said adaptive control portion, and decides an optimum rotation angle based on the received communication quality information.

2. A wireless apparatus in a mobile communication system employing a rotation orthogonal code, comprising the adaptive rotation angle control apparatus according to claim 1, wherein the rotation angle controlled by said adaptive rotation angle control apparatus is used in the rotation orthogonal code.

3. An adaptive rotation angle control method in which reception quality information and amplitude fluctuation information are provided as input information to control a rotation angle used in a rotation orthogonal code, said method comprising the steps of:
calculating a value of a communication quality approximating equation including variables representing reception quality information, amplitude fluctuation information, and a rotation angle by substituting a rotation angle, and said reception quality information and said amplitude fluctuation information provided as said input information, into said communication quality approximating equation;
modifying said rotation angle provided in said calculating step; and
determining an optimum rotation angle based on a communication quality information which is said value of said communication quality approximating equation calculated in said calculating step.

4. A computer program which performs processing to control a rotation angle used in a rotation orthogonal code utilizing reception quality information and amplitude fluctuation information provided as input information, said computer program executing the steps of:
calculating a value of a communication quality approximating equation including variables representing reception quality information, amplitude fluctuation information, and a rotation angle by substituting a rotation angle, and said reception quality information and said amplitude fluctuation information provided as said input information, into said communication quality approximating equation;
modifying said rotation angle provided in said calculating step; and
determining an optimum rotation angle based on a communication quality information which is said value of said communication quality approximating equation calculated in said calculating step.

5. A computer-readable storage medium storing a computer program which performs processing to control a rotation angle used in a rotation orthogonal code utilizing reception quality information and amplitude fluctuation information provided as input information, said computer program executing the steps of:
calculating a value of a communication quality approximating equation including variables representing reception quality information, amplitude fluctuation information, and a rotation angle by substituting a rotation angle, and said reception quality information and said amplitude fluctuation information provided as said input information, into said communication quality approximating equation;
modifying said rotation angle provided in said calculating step; and
determining an optimum rotation angle based on a communication quality information which is said value of said communication quality approximating equation calculated in said calculating step.
